(19) United States
(12) Patent Application Publication
(10) Pub. No.: US 2010/0049790 A1
(43) Pub. Date: Feb. 25, 2010

(54) Virtual Identity System and Method for Web Services

(75) Inventor: Zvi Schreiber, Jerusalem (IL)

Correspondence Address: SIMON KAHN - PYI Tech, Ltd.;c/o LANDONIP, INC, 1725 Jamieson Avenue, ALEXANDRIA, VA, 22314, US

(73) Assignee: GHOST, INC., Tortola (VG)

(21) Appl. No.: 12/530,462

(22) PCT Filed: Mar. 9, 2008
(86) PCT No.: PCT/IL08/00319

§ 371 Date: Sep. 9, 2009

Related U.S. Application Data
(60) Provisional application No. 60/893,968, filed on Mar. 9, 2007.

(51) Int. Cl. G06F 15/16

(52) U.S. Cl. 709/203

(57) ABSTRACT

A comprehensive identity management system for users of multiple Web applications. The system supports multiple standards spanning both inbound and outbound single sign-on and integration with an application directory for coupling discovery of third-party applications with single sign-on.

### CROSS-REFERENCE TO RELATED APPLICATIONS

This application claims priority from U.S. Provisional Patent Application Ser. No. 60/893,968 filed Mar. 9, 2007, entitled “Virtual Hosted Operating System” the entire contents of which is incorporated herein by reference.

This application is further related to the following co-pending, co-filed and co-assigned patent applications, the entire contents of each of which are incorporated herein in their entirety by reference: “VIRTUAL FILE SYSTEM FOR THE WEB” docket GHO-006-PCT; “A GENERAL OBJECT GRAPH FOR WEB USERS”, docket GHO-007-PCT; “SYSTEM AND METHOD FOR BROWSER WITHIN A WEB SITE AND PROXY SERVER” docket GHO-008-PCT; and “SYSTEM AND METHOD FOR A VIRTUAL HOSTED OPERATING SYSTEM” docket GHO-009-PCT.

### BACKGROUND OF THE INVENTION

This application is related to computer software for Web services and more particularly to a system and method for managing a user's identity between multiple web services.

Recently there has been a proliferation of Web-based services which are accessed using a Web browser. Some of these are Web sites which may be browsed anonymously, but many provide content and services which requires the user to “sign up”, i.e. create an account. Creating an account typically includes choosing a username, loading a password and agreeing to a terms-of-service contract. The user must then authenticate himself at all subsequent accesses to the Web site using the username and password in order to access the content, software-as-a-service, e-commerce services or other services at the site.

Unfortunately, the user must then remember all the sites they have accounts with as well as the identify information for each site. The term identity information, as used throughout this application, is meant to include any required logon information, such as username and passwords, without limitation. Optionally, the user may also have a need to record the varying terms of service for each site.

Partial solutions exist in the prior art. Browsers such as Internet Explorer from Microsoft Inc. of Redmond, Wash.; and FireFox from Mozilla Foundation, Mountain View, Calif. will remember usernames and passwords; however the passwords will be remembered only on the physical computer where the usernames and passwords were previously input. Other Web services exist which will remember usernames and passwords; however access to the usernames and passwords is limited to signing on to a Web page.

U.S. Pat. No. 7,137,141 issued Nov. 14, 3006 to McLanahan, entitled “Single sign-on to an underlying operating system application”, the entire contents of which is incorporated herein by reference, teaches single sign-on (SSO) between a physical local operating system and the applications running on it.

The OpenID standard, available from http://openid.net, provides a mechanism for a user to use the identity information from a first web service provider as a login to a second web service provider provided both comply with the OpenID standard and further provided that the second web service provider agrees to rely on the first web service provider for authentication.

The OAuth standard, available from http://oauth.net, provides a mechanism for a user to authorize a second web service provider to make calls to the API of a first web service provider and thus access the users's username and password from the first web service provider, provided that the second web service provider is able to prove that the user has authorized them to access the data.

The OpenSAM standard, available from http://opensam.org, provides a mechanism for SSO between applications. Unlike OpenID, OpenSAM typically deals with a situation that the user is currently in session with a first web service provider and wishes to navigate to a service provided by a second service provider without providing any login identity again. OpenSAM provides mechanisms for the user to authorize a second web service provider to read the user's files from the first web service provider. Unfortunately, the OpenSAM standard requires that both web service providers comply with the OpenSAM standard and that the second web service provider agrees to rely on the first web service provider for authentication.

Other schemes rely on a special identity service provider for capturing a master identity, for example Microsoft Passport from Microsoft Inc. of Redmond, Wash., and the Liberty Alliance, available from http://www.projectliberty.org. Web services may be logged on with unitary identity information, provided that the web service provider agrees to rely on the identity service provider for authentication.

Thus, what is required and not provided for by the prior art, is a system and a method enabling a single sign on for use with multiple applications, which may use multiple authentication schemes, preferably without requiring inter-service agreements or integrations.

### SUMMARY OF THE INVENTION

Accordingly, it is a principal object of the present invention to provide system and a method enabling a single sign on for use with multiple applications. In one embodiment this is provided by a software application, denoted the home application (which may contain other functions besides single sign-on), comprising a server code and an associated client code, the server code being run on a server computer and the client code being run on a client computer at a client location. Communication between the server computer and the client computer is accomplished over a network, such as the Internet using a protocol such as HTTP. The home application provides, inter alia, an identity management system.

A database of user identity information is provided in communication with the server computer. The server code is provided with logon functionality in a plurality of protocols, and is optionally further operative to act as a proxy. The user identity information is accessed and controlled by the identity management system of the home application.

According to some embodiments, a comprehensive system is provided for identity management on the Web. Certain innovations of the method and system, supported in certain embodiments, include providing in a single system some, one or all of:
Inbound single sign-on, i.e. logging in to site A and then hyperlinking to site B without further sign-in;
Inbound third-party sign-on, i.e. logging in to site B using identity credentials from site A;
Outbound single sign-on to Web sites; and
Outbound single sign-on to Web service application program interfaces (APIs).

In particular certain innovations of the method and system, supported in certain embodiments, include providing in a single system some, one or all of:
Allowing a user to link from the home application to third-party services where they have subscriptions without the need to repeat identity information;
If requested by the user, automatically login the user to other services every time they login to the home application;
If requested by the user, maintain a login to other services by repeating the login whenever a time out event occurs;
Providing the user a single application where they can track all their subscriptions to third-party Services and associated terms of service
Login to a third-party application and then hyperlink into the home application without the need for a repeated login
Login to the home application using identity information from a third party service provider; and
Provide the above services not coupled to one physical computer but hosted, so that the user can access the home application and the above benefits from any computer with a Web browser.

In one embodiment, the server code is coupled to a directory of Web services which includes specific technical information about the SSO capabilities of each of the services.

It will be appreciated that this combination of identity-related capabilities provides the user with a seamless identity management system that can greatly change and enhance the experience of the so-called “Netizen” who is using many Web services regularly.

According to one particular embodiment, the system and a method enabling a single sign on for use with multiple applications is coupled to a Web service known as a virtual hosted operating system, which in addition provides one or more of: a hosted desktop in the browser; a windowing system; launching of third-party applications; and a hosted file system.

In certain embodiments the invention provides for a computer implemented identity management system comprising: a server application; a client application; and a database of identity information in communication with at least one of the server application and client application, the database comprising an identifier of a particular one of a plurality of supported protocols associated with each of a plurality of third party Web service, wherein at least one of the server and the client applications are operative to perform single sign on to a selected one of the plurality of third party Web services responsive to the identifier.

In one further embodiment, the single sign on is an outbound single sign on. In another farther embodiment at least one of the plurality of supported protocols provides the outbound single sign on to a Web site launched from the client application. In one yet farther embodiment the Web site is launched in a browser within a browser.

In one further embodiment, the single sign on is triggered automatically for a defined set of URLs. In another further embodiment the single sign on is an inbound single sign on.

In one further embodiment the single sign on is one of an inbound single sign on and an outbound single sign on, the identifier comprising an inbound identifier and an outbound identifier. In another further embodiment the single sign on is an inbound single sign on from a third party application.

In one farther embodiment the server application farther comprises a protocol for third party sign on. In another further embodiment the computer implemented identity management system further comprises a directory of the third Web services in communication with the server application. In one yet farther embodiment the directory contains information regarding account creation with at least one of the third Web services.

In one further embodiment the client application contains a cache of current session IDs. In another farther embodiment the client application contains identifiers of third-party session cookies calculated to be present in a browser.

In one further embodiment the plurality of supported protocols comprise a protocol for application programming interface. In another farther embodiment the plurality of supported protocols comprise a protocol for Web applications.

In one further embodiment the computer implemented identity management system farther comprises a proxy functionality in communication with the server application. In one yet farther embodiment the proxy functionality is operative to add authentication information to requests proxied from the client application.

In certain embodiment the invention independently provides for a computer implemented method of identity management comprising: providing a database of identity information comprising an identifier of a particular one of a plurality of supported protocols associated with each of a plurality of third party Web service; and performing, responsive to a selected one of the plurality of third party Web services, single sign on to the selected third party Web services responsive to the identifier.

In one further embodiment the single sign on is an outbound single sign on. In one yet farther embodiment the computer implemented method of identity management further comprises launching a Web site, the single sign on being to the launched Web site.

In one further embodiment the launched Web site is launched in a browser within a browser. In another farther embodiment the single sign on is triggered automatically for a defined set of URLs.

In one further embodiment the single sign on is an inbound single sign on. In another further embodiment the single sign on is one of an inbound single sign on and an outbound single sign on, the identifier comprising an inbound identifier and an outbound identifier.

In one further embodiment the single sign on is an inbound single sign on from a third party application. In another farther embodiment the server application further comprises a protocol for third party sign on.

In one further embodiment the computer implemented method of identity management further comprises providing a directory comprising information regarding account creation with at least one of the third Web services. In another further embodiment the computer implemented method of identity management further comprises maintaining a cache of current session IDs.

In one further embodiment the computer implemented method of identity management further comprises maintaining identifiers of third-party session cookies calculated to be present in a browser. In another further embodiment the plurality of supported protocols comprise a protocol for application programming interface.

In one further embodiment the plurality of supported protocols comprise a protocol for Web applications. In another further embodiment the computer implemented method of identity management further comprises adding authentication information to requests proxied from the client application.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a high level block diagram of a system architecture, according to certain embodiments of the invention, operable to provide SSO for use with multiple applications;

FIG. 2 illustrates a login screen to a home application according to certain embodiments of the invention;

FIG. 3 illustrates a home application with a third party application embedded in an IFrame according to certain embodiments of the invention;

FIG. 4 illustrates a third party service with one or two IFrames according to certain embodiments of the invention;

FIG. 5 illustrates an alternative user interface for a directory of hosted applications according to certain embodiments of the invention;

FIGS. 6A and 6B, which together form a single figure, illustrate a UML class diagram for matching services with objects and actions according to certain embodiments of the invention;

FIG. 7 illustrates a dialogue for editing the identity repository according to certain embodiments of the invention;

FIG. 8 illustrates a browser within a browser according to certain embodiments of the invention;

FIG. 9 illustrates a method of server-initiated server-Client communication using an innovative HTTP trickle method, according to certain embodiments of the invention;

FIG. 10 illustrates a high level flow chart of a method according to an embodiment of the invention to login to a third party service;

FIG. 11 illustrates a high level flow chart of a method according to an embodiment of an invention to login to a third party service and maintain an issued session ID; and

FIG. 12 illustrates a high level flow chart of a plurality of methods according to an embodiment of an invention to automatically generated a signed API call to a third party Web service provider.

### DETAILED DESCRIPTION OF THE PREFERRED EMBODIMENTS

The present embodiments enable a system and a method providing a single sign on for use with multiple applications. In one embodiment this is provided by a software application, denoted the home application, comprising a server code and an associated client code, the server code being run on a server computer and the client code being run on a client computer at a client location. Communication between the server computer and the client computer is accomplished over a network, such as the Internet. The home application provides, inter alia, an identity management system.

A database of user identity information is provided in communication with the server computer. The server code is provided with logon functionality in a plurality of protocols, and is further operative to act as a proxy. The user identity information is accessed and controlled by the identity management system of the home application.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

### Overall Architecture

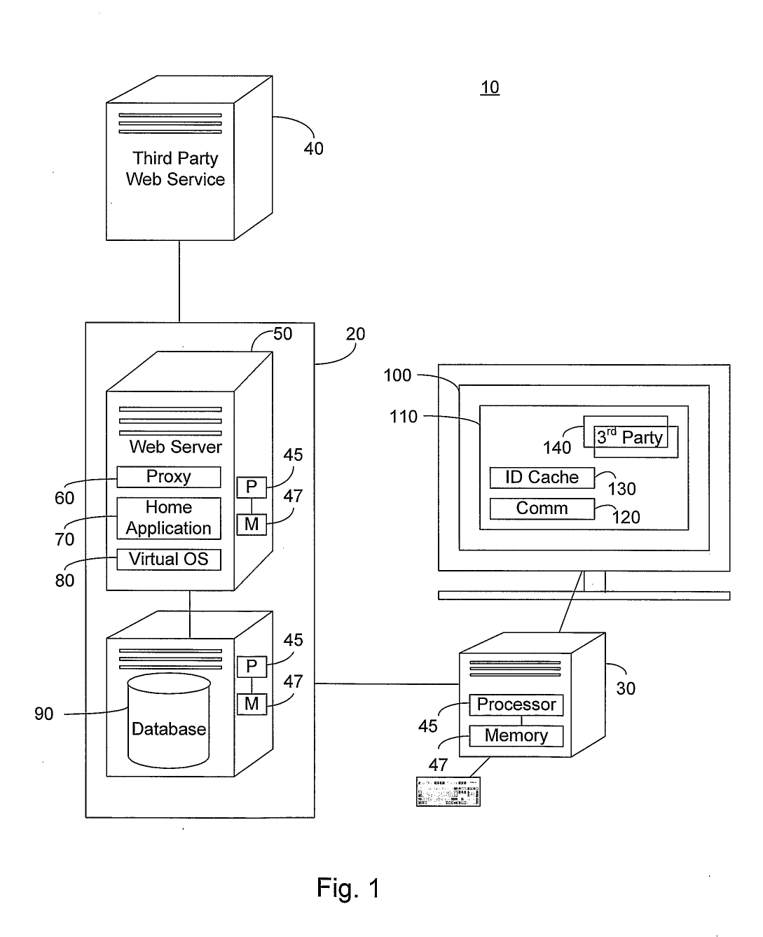

FIG. 1 illustrates a high level block diagram of a system architecture 10, according to certain embodiments of the invention, operable to provide SSO for use with multiple applications. System architecture 10 comprises a home application system server 20, a user computer 30, and a third party Web service provider 40. Home application server 20 comprises a web server 50 exhibiting: a proxy functionality 60; a home application functionality 70; a virtual hosted operating system functionality 80; and a database 90. User computer 30 is shown running a client code 110 of the home application within a Web browser 100. Client code 110 further exhibits a communication module 120, and identity cache 130 and one or more IFrames 140. Each of web server 50, database 90 and user computer 30 comprise a respective processor 45 and a memory 47 in communication with the respective processor 45.

A single home application system server 20 is illustrated, however this is not meant to be limiting in any way. In another embodiment, a series of home application system servers 20 are provided. Home application server 20 hosts the server code of the home application in home application functionality 70, and in particular the identity management system of the home application. Preferably, home application server 20 further provides a full hosted virtual operating system via virtual hosted operating system functionality 80. Each of proxy functionality 60, home application functionality 70 and optional virtual hosted operating system functionality 80, represent software code stored on memory 47 of Web server 20, and are processed by processor 45 of Web server 20.

In operation, a user accesses the system from a computer 30, which is preferably remote from home application system server 20. Computer 30 runs a Web browser 100, shown displayed on a monitor of computer 30. There is no requirement that computer 30 be a fully functional computer, having various user accessible programs, other than Web browser 100. Computer 30 thus may be constituted of a computer terminal, a personal computer, a mobile phone or a set-top box without exceeding the scope of the invention. In general computer 30 is a device allowing access to the Web, and providing for user input.

Client code 110 runs within Web browser 100. Preferably, client code 110 is dynamically downloaded by Web browser 100 from home application system server 20. In one embodiment, client code 110 contains a sequence of static HTML pages generated at home application system server 20 using known technologies such as JSP or ASP. In another embodiment, client code 110 is constituted of code that executes within the Web browser 100 using one or more of: FLASH; Java Applet; Sliverlight; Active-X; and DHTML+Javascript, known as AJAX.

### Identity Repository

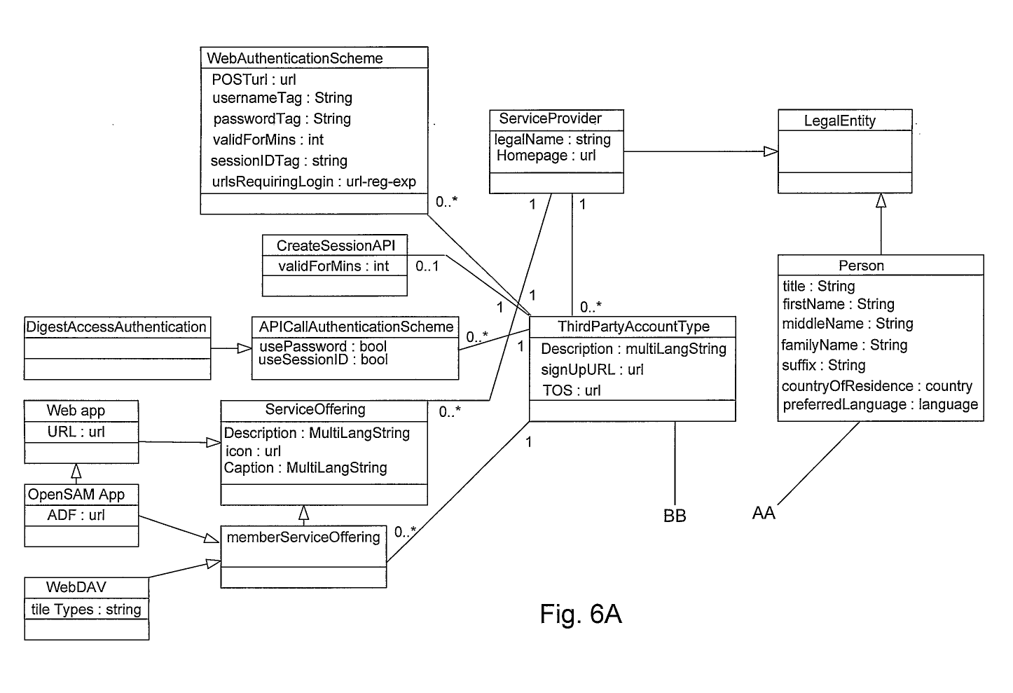

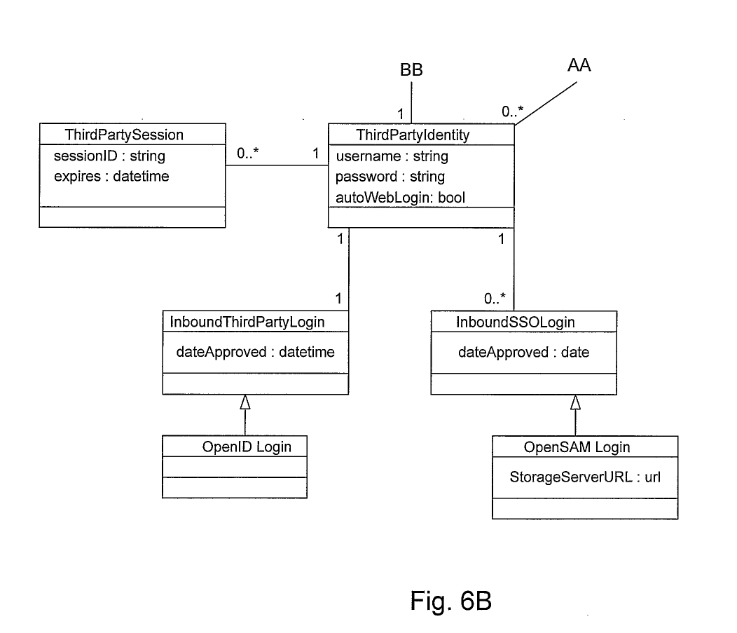

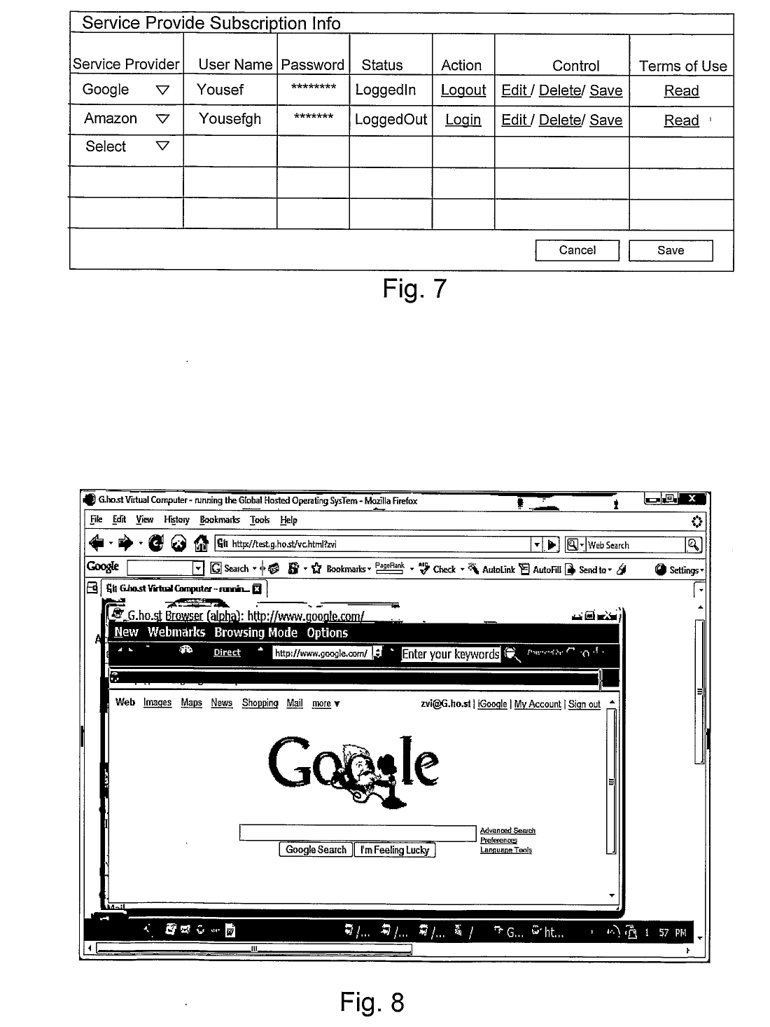

A Web application, as will be described further below in relation to FIG. 6, helps the user to manage their repository of identity information. The identity information, input via the Web application with a user interface such as the tabular format depicted in FIG. 7, is stored on database 90. In one embodiment database 90 is a relational database, available from Oracle Corporation of Redwood Shores, Calif. In another embodiment database 90 is a third-party database service such as SimpleDB from Amazon Inc. of Seattle, Wash. Application functionality 70 comprises business logic running on web server 50. In one embodiment application functionality 70 is constituted of one of a Java servlets or CGI scripts and a user interface as will be described further below in relation to FIG. 7. As described above, application functionality 70 hosts the server portion of the business logic for the identity repository.

Database 90 is illustrated as a server in communication with web server 50, however this is not meant to be limiting in any way. In another embodiment, database 90 is constituted of a database functionality provided on server 50. In operation, database 90 maintains a user's information, including third-party usernames and passwords, and optionally temporary session ID's as will be described further below. In one embodiment, database 90 further maintains data on available third-party applications and on their SSO capabilities.

Client code 110, preferably comprises an identity cache 130 operative to store third party identity information including login information such as username and/or password and/or temporary sessionID. The contents of identity cache 130 are retrieved as required from database 90 and cached in volatile memory, preferably with standard encryption. Identity cache 130 optionally further stores the status of whether a third-party cookie is present in Web browser 100 which grants access to a third-party service.

### Communication

Client code 110 is further provided with communication module 120, which is operative to send requests to home application system server 20 and in particular to proxy functionality 60 and home application functionality 70. In one embodiment, the requests are sent from communication module 120 using standard HTTP requests. In a further embodiment, the HTTP requests are consonant with the design principals of Representational State Transfer (REST), known to those skilled in the art. In another embodiment the HTTP requests are encoded according to the XML-RPC remote call protocol. In yet another embodiment the HTTP requests are consonant with the SOAP protocol.

In the event that home application functionality 70 needs to initiate a communication with client code 110, a difficulty occurs using raw TCP/IP or other protocols due to firewalls which may be installed between Web server 20 and user computer 30. Thus, it is preferable that all communications from home application functionality 70 to client code 100 are in the form of HTTP requests initiated by client code 110, as this kind of communication is permitted by most firewalls. In one embodiment, communication module 120 performs authentication on all outgoing API calls.

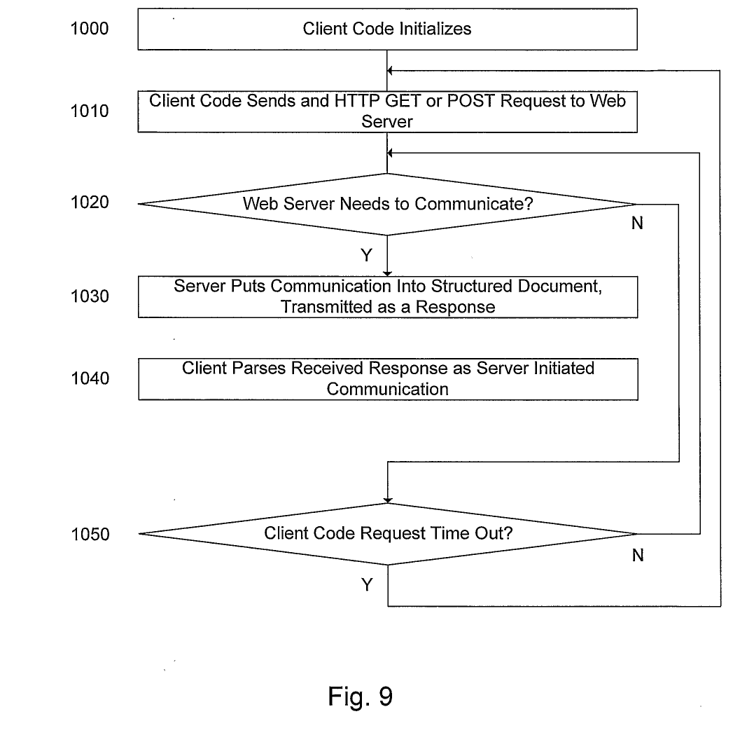

Therefore according to one embodiment server-initiated server-Client communication is implemented using an HTTP trickle method, an embodiment of which will now be detailed in relation to FIG. 9. In stage 1000, client code 110 initializes. In stage 1010, client code 110, irrespective of any need to communicate by client 110, sends an HTTP GET or POST request to Web server 20. In stage 1020 it is determined if Web server 20, and in particular home application functionality 70, has a need to communicate with client code 110.

In the event that in stage 1020, a need to communicate with client code 110 by Web server 20 is determined, in stage 1030, Web server 20 packages the data or commands to be communicated into a structured document, such as an XML document, and transmits the structured document as a reply to outstanding request of stage 1010. In stage 1040, client code 110 parses the received structured document as a server initiated communication. In one embodiment, client code 110 parses the received structured document using a document object module (DOM) as defined by the World Wide Web consortium, of Cambridge, Mass., http://www.w3.org/DOM.

In the event that in stage 1020, there is no need of Web server 20 to communicate with client code 110, in stage 1050, client code 110 determines if its outstanding request of stage 1010 has timed out. It is to be understood that stage 1050 is performed by client code 110, and is thus performed continuously, or responsive to an interrupt at client code 110, orthogonal to the performance of stage 1020 at Web server 20. In the event that in stage 1050 the outstanding request of stage 1010 has timed out, stage 1010 as described above is repeated. In the event that in stage 1050 the outstanding request of stage 1010 has not expired, stage 1020 as described above is repeated. In this manner there is always one HTTP request initiated by client code 110 waiting for a response from Web server 20.

### Digest Asscess Authentication.

### Proxying

In one embodiment, proxy functionality 60 is operative to forward requests from client code 110 to third party Web service providers 40, given that Web browser 100 will often act to prevent client code 110 from communicating with any domain other than the domain it was downloaded from. As indicated above, client code 110 is downloaded from web server 20, and thus client code 110 is restricted to communication with web server 20.

Such proxying is commercially available, e.g. as part of the Laszlo Presentation Server (LPS) from Laszlo Inc. (www.laszlosystems.com) of San Mateo, Calif. or the CGI-Proxy product from James Marshall of Berkeley, Calif. (http://www.jmarshall.com/tools/cgiproxy/). In order to implement this, preferably client code 110 is operative to intercept at least the first request by the user to communicate with third party Web service provider 40, and route the request to proxy functionality 60, passing the target URL as a parameter. In a non-limiting example, instead of sending HTTP request: “GET thirdpartyservice.com” directly, client code 110 will send HTTP request “GET proxy.home-application.com?url=thirdpartyservice.com”. Proxy functionality 60, which is not subject to the limitations which Web browser 100 places on client code 110, is operative to forward this request to its destination.

In one embodiment, proxy functionality 60 is further operative to perform additional services such as one or more of: attaching user's cookies to the forwarded request; and “proxifying” the response, in case it is a web page, so that any hyperlinks or other network calls in the returned web page are themselves adjusted to access the network via the proxy server.

In one embodiment, the proxy server is further operative to add authentication information to calls before forwarding them to the third-party. In one further embodiment the added authentication information is accomplished using the Digest Access Authentication protocol.

### Third-Party Applications

In one embodiment, client code 110 has the ability to launch third-party applications which require SSO. In particular, in one embodiment client code 110 is operative to launch a new browser window, e.g. using a hyperlink with target=“_blank” or an equivalent Javascript command. In another embodiment client code 110 is operative to launch a third party application inside an HTML IFrame, as will be described farther below in relation to FIG. 3.

In one embodiment, a directory of third-party applications with a user interface such as user interface 301 of FIG. 3 is coupled to the home application for finding third-party services and for knowing their SSO capabilities.

Techniques for performing SSO when launching third-party applications are further described below.

### Application Directory

In one embodiment, home application functionality 70 further incorporates a directory of available third-party services. In one embodiment the directory is implemented in a three-tier architecture of a database, a business logic (e.g. using Java servlets) and a presentation layer. The specific object-oriented data model and its coupling to the identity management system will now be described farther. The object oriented model is stored on database 90.

FIGS. 6A and 6B, which together form a single figure, illustrate a UML class diagram for matching services with objects and actions according to certain embodiments of the invention. Below are listed typical classes used, as shown in the diagram, the specific attributes are shown in the figures and only commented on when not self-explanatory:
ServiceProvider: A company which provides Web services, such as Google Inc., Yahoo Inc.;
ThirdPartyAccountType: A set of services you can sign up/on for (usually one per service provider, however this is not restricted);
WebAuthenticationScheme: A scheme for doing SSO for browser Web pages associated with a ThirdPartyAccountType;
CreateSessionAPI: Details of an API for supplying a username and password and receiving a session ID if session id's are supported by this ThirdPartyAccountType (some web services APIs prefer that the username and password is presented once, usually securely over HTTPS, and then a sessionID is generated which is like a temporary password which may be used to authenticate subsequent API calls for a predetermined period of time);
APICallAuthenticationScheme: A scheme for signing/authenticating http calls to APIs associated with the ThirdPartyAccountType (if any) e.g. Digital Access Authentication;
ServiceOffering: A service offered by a ServiceProvider (e.g. a web page, web application software-as-a-service, file storage e.g. with a WebDAV interface, and other APIs ). A WebApp which is launched by pointing a browser at a URL is a particular case; and
MemberServiceOffering: A service which requires an account and sign-on. Providing files or other resources using the WebDAV protocol is a particular case.

It will be appreciated that object-oriented inheritance can be conveniently used to add many specific schemes. By way of a non-limiting example DigitalAccessAuthentication is one way to authenticate API calls.

### Identity Repository

In one embodiment, database 90 comprises a repository of a user's third-party identity information. Preferably, a secure communications standard such as HTTPS is used for transmitting sensitive data such as passwords. An embodiment of an object-oriented data model and in its coupling to the components for automatically executing SSO and in its optional coupling to an application directory will now be further described in relation to FIG. 6B.

Below are listed typical classes used, as shown in the diagram, the specific attributes are shown in the figures and only commented on when not self-explanatory:
ThirdPartyIdentity: Account login credentials (usually username and optionally password) which a home application user supplies for a ThirdPartyAccountType);
ThirdPartySession: A temporary sessionID which has been generated for SSO to a third party, usually valid for a predetermined time period;
ThirdPartyAccountType: A ThirdPartyIdentity which the home application user has asked the home application to trust in lieu of a home application login when hyperlinking to the home application from that service; and
InboundThirdPartyLogin: A ThirdPartyIdentity where the home application user has asked to be able to provide that within the home application in lieu of a home application login.

### Identity Repository API

The identity repository of database 90 preferably has its own API. For example using the HTTP REST style:
Create a login (e.g. store login data to third-party GMail in repository):
POST api.home-application/rest/userLogins/Fred/google/Fred@gmail.com?password=xyz&idSharing=private

Update a login
PUT api.home-application/rest/userLogins/Fred/google/Fred@gmail.com?password=newPw&idSharing=public

Get a user's logins by service providers with passwords:
GET api.home-application/rest/userLogins/Fred/google

Get a session id for a login:
GET api.home-application/rest/userLogins/Fred/google/Fred@gmail.com/sessionId

Sample return value:
<homeAppAPIResponse . . . ><sessionId serviceProvider=“google” accountId=Fred@gmail.com sessionId=“{id}” expires=“{date-time}></ . . . .

### Outbound SSO to Web Sites and Web APPS

### Using Explicit Login/Cookie

Some websites may be launched by explicitly posting the username and password. For example:
POST https://thirdparty.com/main-login
usernm=Fred
passwd=xyz

Such services are preferably stored in the application directory of home application 70 using a WebAuthenticationScheme object. Preferably, at least the URL, tag names for username and password, in the above example ‘usernm’ and ‘passwd’, are saved. Further preferably samples of valid responses, or a characteristic substring such as ‘OK’, and invalid responses, or a characteristic substring such as ‘invalid password’, are provided and stored so that logic can be tested.

In one embodiment, client communications module 120 is operative to open an IFrame using Javascript and point it at the address of the third party service.

Additionally some third party web services will always return a cookie when they respond to a call, such as the above call, and the cookie might be valid for making further HTTP calls from the same browser to the same domain for a period of time. In such a case, identity cache 130 stores a flag indicating that a cookie to a particular third party is present in the browser, and preferably further stores the validity time of the flagged cookie. Thus, subsequent calls to particular third party for which a valid cookie is stored will not require authentication.

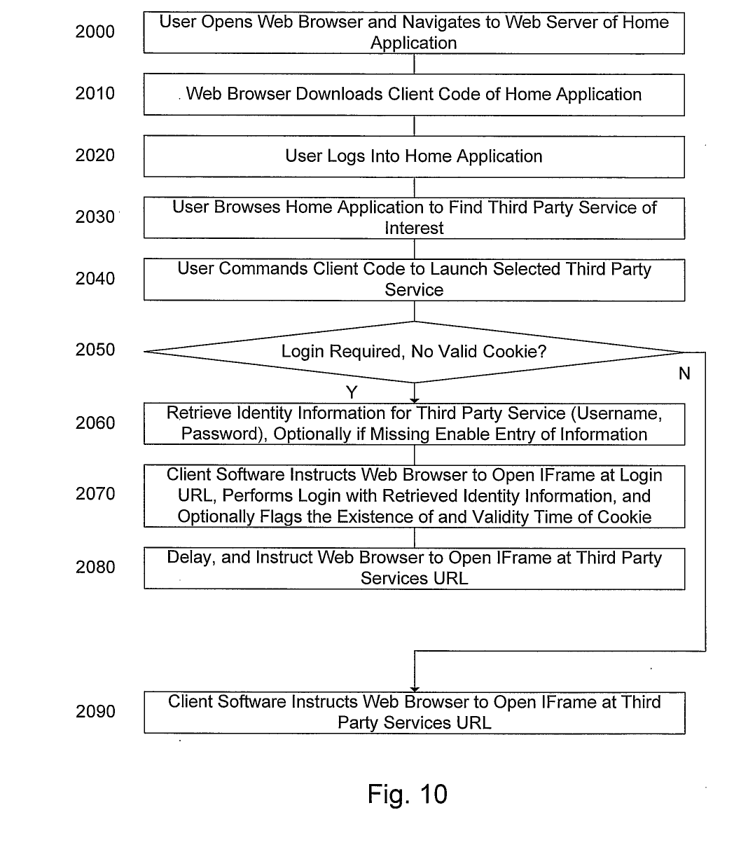

By way of summary of this scenario a typical workflow is described in relation to FIG. 10.

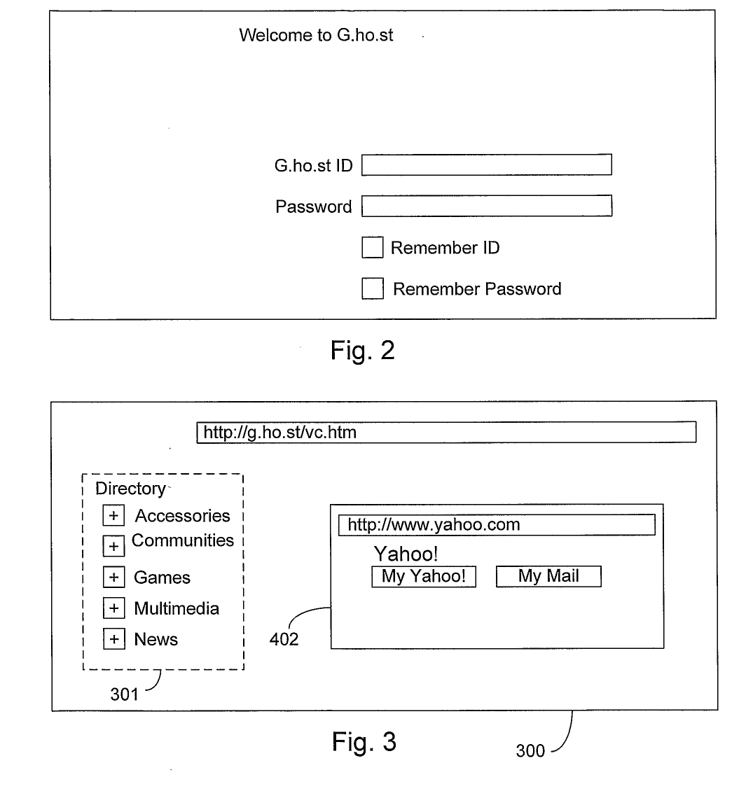

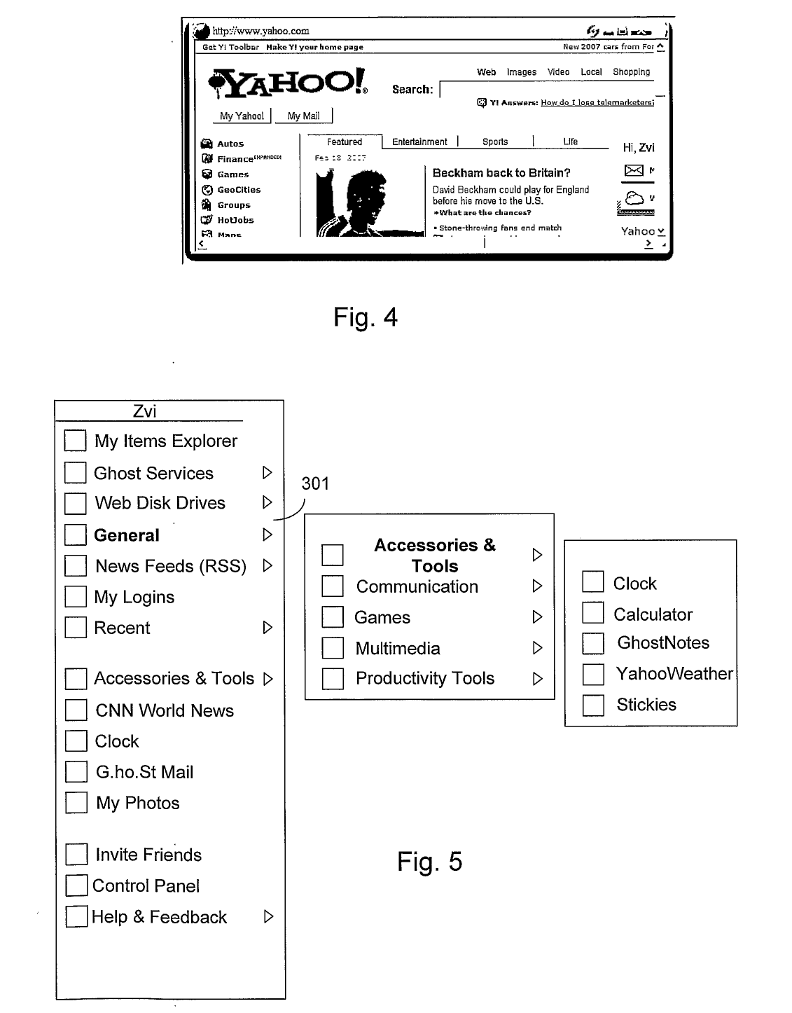

In stage 2000, a user opens Web browser 100 and navigates to a domain associated with Web server 20. In stage 2010, Web browser 100 downloads client software 110. In stage 2020, a user logs in to the home application, using a login screen as shown in FIG. 2. In stage 2030, the user browses to a third party services using an application directory within the home application. In one embodiment the application directory is displayed as a tree directory, as illustrated by directory 301 of FIG. 3.

In stage 2040, the user issues a command to client software 110 to launch a third-party web application found in the directory, by indicating the desired choice such as by clicking on the appropriate link.

In stage 2050, client software 110 queries the directory to find if this service requires Web login. In the event that the service requires login, in stage 2060, client software 110 optionally checks identity cache 130, and if required queries database 90 via home application server 70, preferably via HTTPS, and retrieves user's username and password identity for the user's account with the selected service. Optionally if no username and password are present, the user will be redirected to the user interface of the identity repository, illustrated in FIG. 7, and directed to supply the missing information. Optionally, whenever a new identity is provided by the user, a login is performed immediately to test the validity of the data.

In stage 2070, client software 110 instructs Web browser 100 to open an IFrame 140, or a new browser window, preferably with a POST to the login URL associated with the selected third party service of stage 2040, and transmits the identity information of stage 2060 to perform login. Optionally, client software 110 is aware that the selected third party software has a policy of returning a cookie which is valid for 30 minutes, and identity cache 130 is thus flagged and marked that a valid cookie is in web browser 100 and valid to a time 30 minutes hence. Client software 110 typically cannot examine the cookie directly since it comes from a different domain.

In stage 2080, client software 110 waits a predetermined delay until it presumes that the POST had been responded to, and then commands Web browser 100 to redirect IFrame 140 to ultimate service URL. Web browser 100 will automatically attach the cookie received cookie.

In the event that in stage 2050, client software 110 determines that that the service does not require login, or that a valid cookie is present based on the flag and time marker of identity cache 30, in stage 2090 any new requests by the user to access the service, will be immediately forwarded to Web browser 100 as a command to open an IFrame 140 directed to the service URL.

Applied to Browser within a Browser

Optionally the home application will include a browser with a browser as illustrated in FIG. 8. A browser within a browser may be implemented using Javascript or a Flash-Javascript combination. Responsive to a user input URL, or the selection of a URL from a directory, client code 110 instructs Web browser 110 to create an IFrame 140 and to point it at the URL, either directly or via proxy functionality 60.

In accordance with an embodiment of the invention, and as described above in relation to FIG. 10, responsive to a user input URL (e.g. shown in the example as http://www.google.com) which, according to the application directory information stored on database 90, requires authentication, client code 110 will preferably automatically perform the above process for outbound SSO to Web sites and Web applications. Specifically the WebAuthenticationScheme object of FIG. 6A has an attribute urlsRequiringLogins which contains a regular expression matching whichever URLs require login (for example there may be a record showing that *.google.com requires login to a Google Inc. account where * is a wild card). Optionally, a user may select a preference in any ThirdPartyIdentity object, to indiciate whether autoWebLogin is actually enabled (for example this user may indicate that they always want auto-login when navigating to *.google.com).

### Using Session ID

In this alternative scenario the third-party service provide is arranged to issue session IDs which are valid for authentication instead of a username and password for a period of time. An advantage is that the session ID may be retrieved from the server and then sent to the Client for the Client to use in authentication without the security risk of sending the username and password to the client.

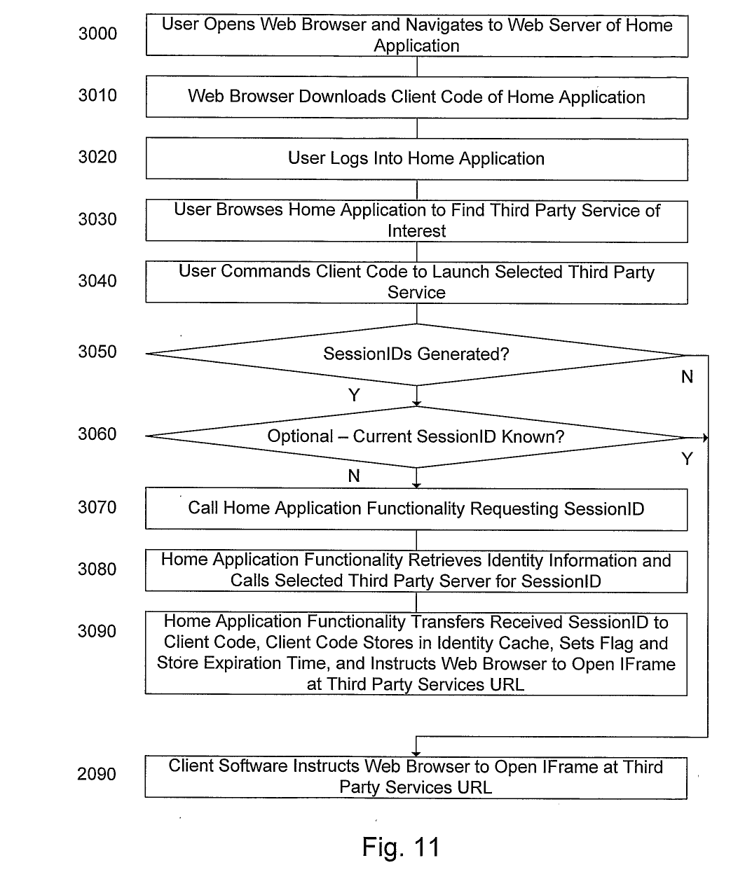

FIG. 11 illustrates a high level flow chart of a method according to an embodiment of an invention to login to a third party service and maintain an issued session ID. In stage 3000, a user opens Web browser 100 and navigates to a domain associated with Web server 20. In stage 3010, Web browser 100 downloads client software 110. In stage 3020, a user logs in to the home application, using a login screen as shown in FIG. 2.

In stage 3030, the user browses to a third party services using an application directory within the home application. In one embodiment the application directory is displayed as a tree directory, as illustrated by directory 301 of FIG. 3. In stage 3040, the user issues a command to client software 110 to launch a third-party web application found in the directory, by indicating the desired choice such as by clicking on the appropriate link.

In stage 3050, client software 110 queries the directory to find if this service exhibits an API for generating sessions IDs which may be used instead of Web login. The existence of the API is documented in a CreateSessionAPI object within the applications directory on database 90.

In the event that the existence of the API is confirmed, in stage 3060 client software 110 optionally checks identity cache 130, and if required queries database 90 via home application server 70, preferably via HTTPS, to see if current sessionID is known. In the event that a current sessionID is not known, in stage 3070 a call is made to home application functionality 70 requesting a sessionID. In stage 3080, home application server 70 queries database 90 for the user's identity information, preferably comprising a username and password, and send them to third-party web service provider 50 using a call such as POST https://fourth-party.com/api/getSessionID?username=Fred&password=xyz. The returned sessionID will be returned to client code 110 and/or stored in database 90 and/or cached by client code 110 in identity cache 130.

In stage 3090, client code 110 instructs browser 100 to open an IFrame 140 the selected third party URL, including the sessionID information. In one non-limiting example the call is of the format: http://thirdparty.com/SomeService?sessionID=12345. Client code 110 further sets a flag and stored an expiration time for the retrieved sessionID, preferably both of which are stored in identity cache 130. A valid sessionID is treated in all respects similar to a valid cookie as described above in relation to FIG. 10. Thus, any further requests by the user to access the same third party while the retrieved sessionID remains valid, will be treated as described above in relation to stage 2090.

In the event that in stage 3050 the existence of the API for generating sessionIDs is not confirmed then stage 2090 might be performed without SSO or the system might check for the availability of a different authentication scheme for this site. In the event that in stage 3060 a current sessionID is known, stage 2090 as described above is performed including attaching the sessionID to the URL (directly or as part of a digest as required) to achieve authentication.

### Outbound SSO to Web Service APIs

Another scenario is that the home application functionality 70 or client code 110, on behalf of the user, is instructed to make API calls to a third-party Web service provider 140. For example, client code 110 may be configured to retrieve data for automatic processing by home application functionality 70 or client code 110, instead of displaying a third-party Web app in a separate IFrame 140 as described above. For example, the user may have files stored with a third-party Web service provider 40 which are accessible using an API such as WebDAV.

Such an API call will require authentication. Cookies are not usually used, more often the calling party will ‘digitally sign’ the call by attaching a digest of the call together with identity information, such as a username and password or a sessionID, preferably further using known cryptographical techniques.

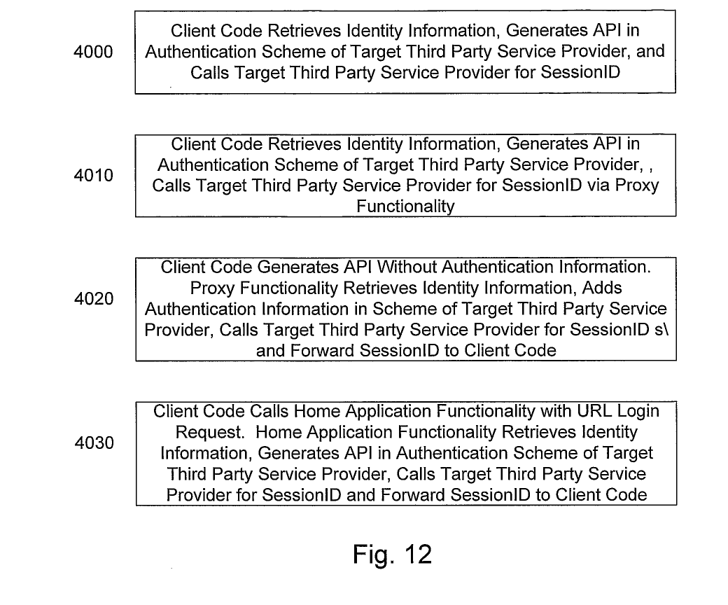

FIG. 12 illustrates a high level flow chart of a plurality of methods according to an embodiment of an invention to automatically generated a signed API call to a third party Web service provider.

In method 4000, if allowed by browser 100, an API generator of client code 110 generates a URL with authentication and calls third party Web service provider 40. In method 4010, client code 110 communicates with proxy functionality 60, and transmits the generated API to proxy functionality 60. Proxy functionality 60 is operative to call service provider 40 with signed API received from client code 110.

In method 4020, an API generator of client code 110 generates a URL without authentication and calls proxy functionality 60. Proxy functionality 60, queries database 90, retrieves the required identity information, adds the authentication and forwards the request to third party Web service provider 40. Upon return of the sessionID, or other information, proxy functionality 60 forwards the received information to client code 110.

In method 4030, an API generator of client code 110 calls server home application functionality 70, with the URL login request. Home application functionality 70, is equipped with an implementation of the WebDAV API, or other API as required, and generates the call to third party Web service provider 40, in cooperation with identity information stored on database 90. Upon return of the sessionID, or other information, proxy functionality 60 forwards the received information to client code 110.

In every one of these four methods there are common steps:

Before making a third-party API call the application directory stored on database 90, or copied into identity cache 130, is consulted to discover the API authentication scheme(s) supported by the third-party

If a sessionID is required, or desired, database 90 or identity cache 130 is consulted for an existing sessionID; and if not present the CreateSessionAPI record is consulted and an API call is generated to get a sessionID which is then preferably stored in database 90 and/or cached in identity cache 130.

The APICallAuthenticationScheme(s) is retrieved. In the event that more than one scheme is available, one is chosen according to what is preferred by the service provider or the protocol considered more secure or efficient by the home application. Each major protocol code is available to authenticate the API. Thus, advantageously, irrespective of the protocol code of the selected third party Web service provider 40, access can be achieved.

The authenticated API call is forwarded to third-party Web service provider 40.

### Inbound SSO

In this scenario a user logs into a web site of a third party Web service provider 40 and then links to the home application. The third-party application uses a standard such as OpenSAM to tell the home application that the user is logged into the third-party, typically providing the username but not the password. Responsive thereto, the home application will typically call back to the third party Web service provider 40 to make sure the call is valid. In an alternative embodiment, the third party Web service provider 40 might provide a digital signature to validate the origin of the call without the need for a call back.

The home application may exhibit one of a number of different policies as follows:
Accept the third-party username as a valid username in the home application's own user database. Optionally an account can be created on demand the first time an inbound SSO occurs.
Require the user to creates an account in the home application with a userid recognized by the home application, but that account can then be associated with the inbound SSO third-party ID as an alternative way to login (captured in an InboundSSO login object)

Here is a typical scenario according to the second alternative:

A user is logged in and is browsing a third-party application and clicks on a link to HomeApplication.

The third-party application opens HomeApplication.com in an IFrame or pop-up and attaches several HTTP parameters defining the calling application: user id; optional session id; optional user preferences (e.g. language=French or font, color, date format preferences etc.); and a server to call back for authentication or digital signature.

The user receives a Home Application welcome screen such as the one illustrated in FIG. 2 with the following extra features
The text “Welcome <Name>[<userid>] from <name of referring application>”

Under the login there is an extra checkbox “[ ] Single-sign on with <name of referring application>” and help text “Next time I login directly from the same third-party application, take me directly to my account. This implies that I want Home Application to trust the third-party application to identify me (and Home Application will take anyone identified as me by the third-party application directly to my desktop)”

In case the user does not yet have an account with Home Application, at the bottom of the registration form there is an extra checkbox “[ ] Single-sign on with <name of referring application>” and help text “Next time I login directly from the third-party application, take me directly to my account. This implies that I want Home Application to trust the third-party application to identify me (and Home Application will take anyone identified as me by the third-party application directly to my desktop)”

If the user asks for the SSO in either the login or registration, then next time the user does SSO from the same account and vendor we will be logged in directly.

### Inbound Third-Party Sign On

In this scenario a user navigates to the home application but asks to sign-on using the username and password from a third-party which home application trusts to do authentication. The home application uses a standard such as OpenID to allow the user to provide their login credentials directly to the third-party and to allow the third-party to confirm the authentication to the home application.

The home application may exhibit one of a number of different policies as follows:
Accept the third-party username as a valid username in the home application's own user database. Optionally an account can be created on demand the first time an inbound SSO occurs
Alternatively the home application can require that the user creates an account in the home application with a userid recognized by the home application—but that account can then be associated with the inbound SSO third-party id as an alternative way to login (captured in an InboundSSO login object)

In the second case an InboundThirdPartyLogin object may be used and stored in database 90 to associate the home application account with the third-party login to capture that the user wants to the home application to rely on that third party login for authentication to the home application.

### Sign Up

Preferably according to an embodiment of the invention client code 110 may also help the user to create accounts with third parties.

In one embodiment this involves referring the user to the third-party's sign-up page opened e.g. in an iframe or pop-up window. In such an embodiment, signUpUrl is an optional attribute of ThirdPartyAccountType as illustrated in FIG. 6A.

Preferably though third-party accounts may be made using an API call. For example an API may be a POST with tags equivalent to for example
Preferred username
Preferred password
FirstName
FamilyName
DateOfBirth
Country
PreferredLanguage

and other parameters typical of registration. For each such parameter a tag name and an indicator or required/optional/not-supported may all be added to the application directory, stored in database 90, so that there is enough data for automatic sign-up to the third-party.

Preferably the home application will digitally sign calls to the third-party sign-up API so that the third-party can trust the call. Preferably it is up to the home application to require a “captcha” test to validate that the user is human before generating a sign-up request.

Thus, the present embodiments enable a system and a method providing a single sign on for use with multiple applications. In one embodiment this is provided by a software application, denoted the home application, comprising a server code and an associated client code, the server code being run on a server computer and the client code being run on a client computer at a client location. Communication between the server computer and the client computer is accomplished over a network, such as the Internet. The home application provides, inter alia, an identity management system.

A database of user identity information is provided in communication with the server computer. The server code is provided with logon functionality in a plurality of protocols, and is further operative to act as a proxy. The user identity information is accessed and controlled by the identity management system of the home application.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

I claim:

1. A computer implemented identity management system comprising:
a server application;
a client application; and
a database of identity information in communication with at least one of said server application and client application, said database comprising an identifier of a particular one of a plurality of supported protocols associated with each of a plurality of third party Web service,
wherein at least one of said server and said client applications are operative to perform single sign on to a selected one of said plurality of third party Web services responsive to said identifier.

2. A computer implemented identity management system according to claim 1, wherein said single sign on is an outbound single sign on.

3. A computer implemented identity management system according to claim 2, wherein at least one of said plurality of supported protocols provides said outbound single sign on to a Web site launched from the client application.

4. A computer implemented identity management system according to claim 3, wherein the Web site is launched in a browser within a browser.

5. A computer implemented identity management system according to claim 1, wherein said single sign on is triggered automatically for a defined set of URLs.

6. A computer implemented identity management system according to claim 1, wherein said single sign on is an inbound single sign on.

7. A computer implemented identity management system according to claim 1, wherein said single sign on is one of an inbound single sign on and an outbound single sign on, said identifier comprising an inbound identifier and an outbound identifier.

8. A computer implemented identity management system according to claim 1, wherein said single sign on is an inbound single sign on from a third party application.

9. A computer implemented identity management system according to claim 1, wherein said server application further comprises a protocol for third party sign on.

10. A computer implemented identity management system according to claim 1, further comprising a directory of said third Web services in communication with said server application.

11. A computer implemented identity management system according to claim 10, wherein the directory contains information regarding account creation with at least one of said third Web services.

12. A computer implemented identity management system according to claim 1, wherein said client application contains a cache of current session IDs.

13. A computer implemented identity management system according to claim 1, wherein said client application contains identifiers of third-party session cookies calculated to be present in a browser.

14. A computer implemented identity management system according to claim 1, wherein said plurality of supported protocols comprises a protocol for application programming interface.

15. A computer implemented identity management system according to claim 1, wherein said plurality of supported protocols comprises a protocol for Web applications.

16. A computer implemented identity management system according to claim 1, further comprising a proxy functionality in communication with said server application.

17. A computer implemented identity management system according to claim 16, wherein said proxy functionality is operative to add authentication information to requests proxied from said client application.

18. A computer implemented method of identity management comprising:
providing a database of identity information comprising an identifier of a particular one of a plurality of supported protocols associated with each of a plurality of third party Web service; and
performing, responsive to a selected one of the plurality of third party Web services, single sign on to said selected third party Web services responsive to said identifier.

19. A computer implemented method of identity management according to claim 18, wherein said single sign on is an outbound single sign on.

20. A computer implemented method of identity management according to claim 19, further comprising launching a Web site, said single sign on being to said launched Web site.

21. A computer implemented method of identity management according to claim 19, wherein the launched Web site is launched in a browser within a browser.

22. A computer implemented method of identity management according to claim 19, wherein said single sign on is triggered automatically for a defined set of URLs.

23. A computer implemented method of identity management according to claim 19, wherein said single sign on is an inbound single sign on.

24. A computer implemented method of identity management according to claim 19, wherein said single sign on is one of an inbound single sign on and an outbound single sign on, said identifier comprising an inbound identifier and an outbound identifier.

25. A computer implemented method of identity management according to claim 19, wherein said single sign on is an inbound single sign on from a third party application.

26. A computer implemented method of identity management according to claim 19, wherein said server application further comprises a protocol for third party sign on.

27. A computer implemented method of identity management according to claim 19, further comprising providing a directory comprising information regarding account creation with at least one of said third Web services.

28. A computer implemented method of identity management according to claim 19, further comprising maintaining a cache of current session IDs.

29. A computer implemented method of identity management according to claim 19, further comprising maintaining identifiers of third-party session cookies calculated to be present in a browser.

30. A computer implemented method of identity management according to claim 19, wherein said plurality of supported protocols comprises a protocol for application programming interface.

31. A computer implemented method of identity management according to claim 19, wherein said plurality of supported protocols comprises a protocol for Web applications.

32. A computer implemented method of identity management according to claim 19, further comprising adding authentication information to requests proxied from said client application.
